(19) United States
(12) Patent Application Publication
(10) Pub. No.: US 2026/0135987 A1
(43) Pub. Date: May 14, 2026

(54) DISPLAY DEVICE AND DISPLAY SYSTEM

(71) Applicant: Magnolia White Corporation, Tokyo (JP)

(72) Inventor: Yoshihiro WATANABE, Tokyo (JP)

(73) Assignee: Magnolia White Corporation, Tokyo (JP)

(21) Appl. No.: 19/441,979

(22) Filed: Jan. 7, 2026

Related U.S. Application Data
(63) Continuation of application No. PCT/JP2024/019488, filed on May 28, 2024.

(30) Foreign Application Priority Data
Jul. 14, 2023 (JP) 2023-115946

(51) Int. Cl. H04N 13/383; H04N 13/324; H04N 13/398

(52) U.S. Cl. CPC H04N 13/383; H04N 13/324; H04N 13/398

(57) ABSTRACT

According to an aspect, a display device includes: a display panel having a display region; a light source device configured to emit first light in a first color, second light in a second color, and third light in a third color to the display panel in a stated order; a line-of-sight detection sensor; and a drive circuit configured to display an image in the display region. The drive circuit is configured to: display a first color image, a second color image, and a third color image; identify a position of a point of view of a user in the display region based on a detection result of the line-of-sight detection sensor; and adjust positions of the first color image, the second color image, and the third color image with respect to the display region based on a positional relation between the points of view of the user.

### CROSS-REFERENCE TO RELATED APPLICATION

This application claims the benefit of priority from Japanese Patent Application No. 2023-115946 filed on Jul. 14, 2023 and International Patent Application No. PCT/JP 2024/019488 filed on May 28, 2024, the entire contents of which are incorporated herein by reference.

### BACKGROUND

### 1. Technical Field

What is disclosed herein relates to a display device and a display system.

### 2. Description of the Related Art

Japanese Patent Application Laid-open Publication No. 2010-276966 (JP-A-2010-276966) discloses an image display device (display device) that displays images by a field-sequential color system. The display device disclosed in JP-A-2010-276966 controls the display order of field images in a plurality of colors that are displayed by the field-sequential color system based on the luminance distribution on the observer's retina. Thus, the display device reduce the occurrence of color breaking (what is called color breakup) in which field images are visually recognized as an afterimage or the like.

The color breakup described above may possibly occur, for example, when the observer's line of sight moves. It is desirable for display devices to further reduce color breakup.

For the foregoing reasons, there is a need for reducing the occurrence of color breakup in a display device that displays images by a field-sequential color system.

### SUMMARY

According to an aspect, a display device includes: a display panel having a display region; a light source device configured to emit first light in a first color, second light in a second color, and third light in a third color to the display panel in one frame in the order of the first light, the second light, and the third light; a line-of-sight detection sensor configured to detect a line of sight of a user; and a drive circuit configured to display an image in the display region based on an image signal. The drive circuit is configured to: generate a first color image corresponding to the first color, a second color image corresponding to the second color, and a third color image corresponding to the third color based on the image signal; display the first color image when the first light is emitted, the second color image when the second light is emitted, and the third color image when the third light is emitted; identify a position of a point of view of the user in the display region based on a detection result of the line-of-sight detection sensor; use the identified position of the point of view of the user to determine a position of a first point of view serving as the point of view of the user in the display region when the first color image is displayed, a position of a second point of view serving as the point of view of the user in the display region when the second color image is displayed, and a position of a third point of view serving as the point of view of the user in the display region when the third color image is displayed; and adjust a position of the first color image, a position of the second color image, and a position of the third color image with respect to the display region based on a positional relation between the first point of view, the second point of view, and the third point of view.

### BRIEF DESCRIPTION OF THE DRAWINGS

FIG. 1 is a perspective view of a display device according to an embodiment of the present disclosure;

FIG. 2 is a sectional view of the display device;

FIG. 3 is a diagram of a circuit configuration of a display panel;

FIG. 4 is a sectional view of the display panel;

FIG. 5 is a diagram of an example of an input image;

FIG. 6 is a diagram of a first color image corresponding to the input image illustrated in FIG. 5;

FIG. 7 is a diagram of a second color image corresponding to the input image illustrated in FIG. 5;

FIG. 8 is a diagram of a third color image corresponding to the input image illustrated in FIG. 5;

FIG. 9 is a diagram of operations of a drive circuit and a light source device performed when an image is displayed on the display panel;

FIG. 10 is a diagram of an example of an image visually recognized by a user when color breakup occurs;

FIG. 11 is a flowchart executed by an image processing circuit;

FIG. 12 is a diagram of an example of the position of a gaze point when the color image is displayed;

FIG. 13A is a graph indicating the transition in an X-direction of a plurality of gaze points illustrated in FIG. 12;

FIG. 13B is a graph indicating the transition in a Y-direction of the gaze points illustrated in FIG. 12;

FIG. 14 is a flowchart executed by the image processing circuit;

FIG. 15 is a diagram of the second color image the position of which is adjusted with respect to a display region;

FIG. 16 is a diagram of the first color image the position of which is adjusted with respect to the display region;

FIG. 17 is a diagram of the third color image the position of which is adjusted with respect to the display region;

FIG. 18 is a perspective view of a display system according to the embodiment of the present disclosure;

FIG. 19 is a schematic of the configuration of the display system;

FIG. 20 is a block diagram of the display system; and

FIG. 21 is a flowchart executed by the drive circuit to display a color image in the display device included in the display system.

### DETAILED DESCRIPTION

An exemplary embodiment of the present disclosure is described below with reference to the accompanying drawings. The content described in the embodiment below is not intended to limit the present disclosure. Components described below include components easily conceivable by those skilled in the art and components substantially identical therewith. Furthermore, the components described below may be appropriately combined.

What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by the same reference numerals, and detailed explanation thereof may be appropriately omitted.

X -and Y-directions in the drawings correspond to the directions parallel to the plate surface of a substrate included in a display device 1. The +X and −X sides in the X-direction and the +Y and −Y sides in the Y-direction correspond to the sides of the display device 1. A Z-direction corresponds to the thickness direction of the display device 1. The +Z side in the Z-direction corresponds to the front surface side on which images are displayed in the display device 1, and the −Z side in the Z-direction corresponds to the back surface side of the display device 1. In the present specification, “plan view” refers to viewing the display device 1 from the +Z side to the −Z side along the Z-direction. The X-, Y-, and Z-directions are given by way of example only and are not intended to limit the present disclosure.

### Display Device 1

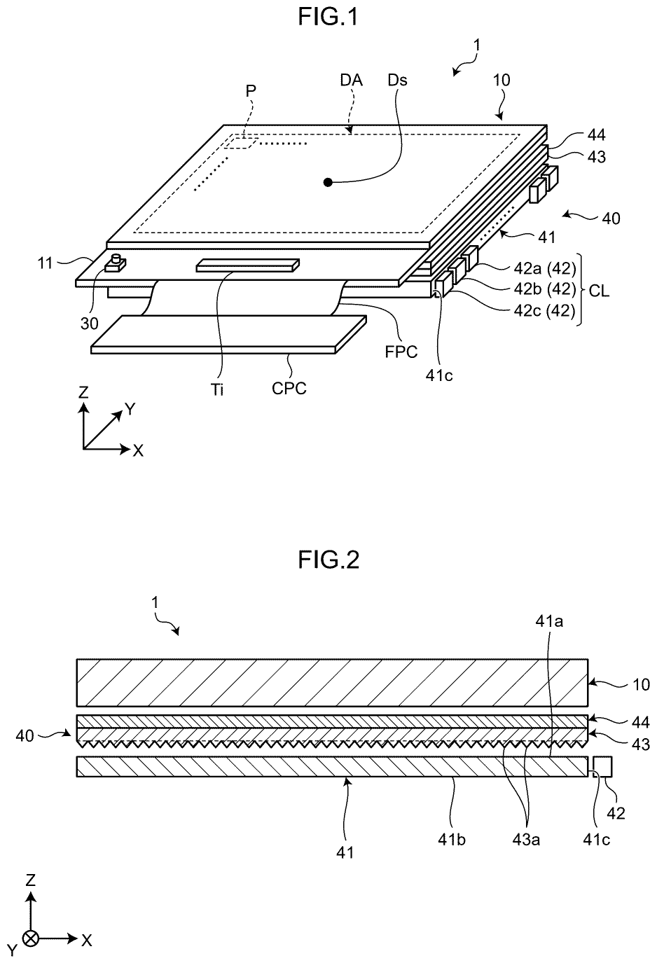

FIG. 1 is a perspective view of the display device 1 according to an embodiment of the present disclosure. FIG. 2 is a sectional view of the display device 1.

The display device 1 displays images based on image signals output from an external device (not illustrated) wired or wirelessly coupled thereto. The display device 1 includes a display panel 10, a drive circuit 20, a line-of-sight detection sensor 30, and a light source device 40.

The display panel 10 is a transmissive liquid crystal display. The display panel 10 may be, for example, a projection display with a reflective liquid crystal and a digital mirror device (DMD), an organic EL display, or an inorganic EL display. The display panel 10 has a rectangular plate shape in plan view and has a display region DA for displaying images on the front surface. The display region DA has a rectangular shape in plan view and has a reference point Ds at the center. The reference point Ds may be at a position other than the center and be on the periphery of the display region DA, for example. The display panel 10 includes a plurality of pixels P arranged in a matrix (row-column configuration) along the X- and Y-directions in the display region DA.

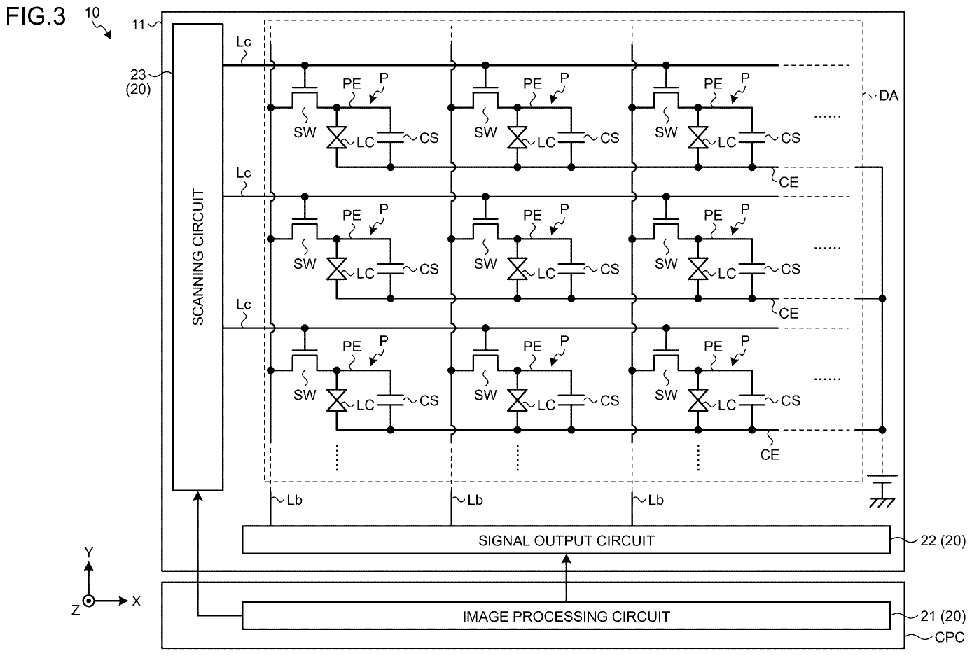

FIG. 3 is a diagram of a circuit configuration of the display panel 10. Each of the pixels P of the display panel 10 includes a switching element SW, a pixel electrode PE, a common electrode CE, liquid crystal capacitance LC, and holding capacitor CS. A first substrate 11, which will be described later, of the display panel 10 illustrated in FIG. 1 is provided with an IC chip Ti. The first substrate 11 is electrically coupled to a control substrate CPC via a flexible substrate FPC. The IC chip Ti and the control substrate CPC is provided with the drive circuit 20.

The drive circuit 20 displays images in the display region DA based on the image signals transmitted from the external device. As illustrated in FIG. 3, the drive circuit 20 includes an image processing circuit 21, a signal output circuit 22, and a scanning circuit 23. The image processing circuit 21 is provided to the control substrate CPC coupled to the first substrate 11. The signal output circuit 22 and the scanning circuit 23 are provided on the IC chip Ti (FIG. 1) included in the first substrate 11.

The image processing circuit 21 generates a plurality of pixel signals, which will be described later, based on the image signals and outputs the generated pixel signals to the signal output circuit 22. The image processing circuit 21 outputs, to the signal output circuit 22 and the scanning circuit 23, clock signals for synchronizing the operation of the signal output circuit 22 with the operation of the scanning circuit 23.

The signal output circuit 22 outputs the pixel signals to the respective pixels P. As illustrated in FIG. 3, the signal output circuit 22 and the pixels P are electrically coupled via a plurality of signal lines Lb extending along the Y-direction.

The scanning circuit 23 scans the pixels P in synchronization with the output of the pixel signals by the signal output circuit 22. The scanning circuit 23 and the pixels P are electrically coupled via a plurality of scanning lines Lc extending along the X-direction.

The switching element SW is composed of a thin-film transistor (TFT), for example. In the switching element SW, the source electrode is electrically coupled to the signal line Lb, and the gate electrode is electrically coupled to the scanning line Lc.

The pixel electrode PE is coupled to the drain electrode of the switching element SW. A plurality of common electrodes CE are disposed corresponding to the scanning lines Lc. The pixel electrode PE and the common electrode CE have a light-transmitting property.

The liquid crystal capacitance LC is a capacitance component of the liquid crystal material of a liquid crystal layer 13, which will be described later, between the pixel electrode PE and the common electrode CE. The holding capacitor CS is provided between the electrode with the same potential as that of the common electrode CE and the electrode with the same potential as that of the pixel electrode PE.

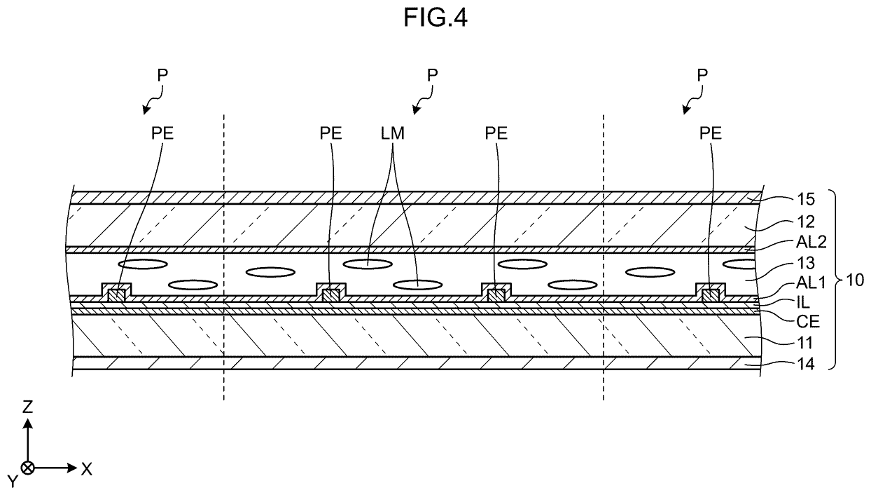

FIG. 4 is a sectional view of the display panel 10. The display panel 10 further includes the first substrate 11, a second substrate 12, and the liquid crystal layer 13. The first substrate 11, the liquid crystal layer 13, and the second substrate 12 have a light-transmitting property and are disposed in this order from the −Z side to the +Z side along the Z-direction. The first substrate 11 and the second substrate 12 have a rectangular shape in plan view and are made of resin, such as polyethylene terephthalate, or glass.

The common electrode CE is disposed on the front surface of the first substrate 11. An insulating layer IL is disposed on the front surface of the common electrode CE. The pixel electrodes PE and a first orientation film AL1 are disposed on the front surface of the insulating layer IL.

The pixel electrodes PE are disposed between the insulating layer IL and the first orientation film AL1. Thus, the common electrode CE and the pixel electrodes PE are disposed on the first substrate 11. In other words, the display panel 10 is a lateral electric field liquid crystal display.

The second substrate 12 is positioned on the front surface side of the first substrate 11. A second orientation film AL2 is disposed on the back surface of the second substrate 12. The orientation directions of the first orientation film AL1 and the second orientation film AL2 are parallel to each other. The orientation directions of the first orientation film AL1 and the second orientation film AL2 may be orthogonal to each other. FIG. 4 does not illustrate the signal lines Lb or the scanning lines Lc. The signal lines Lb and the scanning lines Lc are disposed on the front surface of the first substrate 11.

The liquid crystal layer 13 includes a plurality of liquid crystal molecules LM. The liquid crystal layer 13 is provided between the first substrate 11 and the second substrate 12 and overlaps the display region DA in plan view. Specifically, the liquid crystal layer 13 is provided between the first orientation film AL1 and the second orientation film AL2. The orientation of the liquid crystal molecules LM is regulated by the first orientation film AL1 and the second orientation film AL2.

The display panel 10 further includes a first polarizing plate 14 disposed on the back surface of the first substrate 11 and a second polarizing plate 15 disposed on the front surface of the second substrate 12. The first polarizing plate 14 has a transmission axis orthogonal to the Z-direction. The second polarizing plate 15 has a transmission axis orthogonal to the transmission axis of the first polarizing plate 14 and the Z-direction. The front surface of the second polarizing plate 15 corresponds to the front surface of the display panel 10. The back surface of the first polarizing plate 14 corresponds to the back surface of the display panel 10.

The line-of-sight detection sensor 30 illustrated in FIG. 1 is provided to the display panel 10. The line-of-sight detection sensor 30 detects the user's line of sight by an eye tracking technology. The results of detection by the line-of-sight detection sensor 30 are output to the image processing circuit 21. The line-of-sight detection sensor 30 captures the movement of the user's eyeball at a predetermined frequency (e.g., 120 Hz). The captured data is output to the image processing circuit 21. The image processing circuit 21 detects the direction of the line of sight at a predetermined period (e.g., 8.33 ms) and records the detection results as time-series data. The number of pieces of data recorded in the image processing circuit 21 is the number of pieces (e.g., 120 pieces) for a predetermined time (e.g., one second). The data is overwritten from the oldest data every time the data captured by the line-of-sight detection sensor 30 is output to the image processing circuit 21. Therefore, the image processing circuit 21 always holds the latest data of the number of pieces for the predetermined time.

The light source device 40 illustrated in FIGS. 1 and 2 outputs light toward the display panel 10. The light source device 40 includes a light guide plate 41, a plurality of first light emitters 42a, a plurality of second light emitters 42b, a plurality of third light emitters 42c, a prism sheet 43, and a diffusion sheet 44. In the following description, the first light emitter 42a, the second light emitter 42b, and the third light emitter 42c may be referred to simply as “light emitters 42” when they are not distinguished from one another.

In the light source device 40, the light guide plate 41, the prism sheet 43, and the diffusion sheet 44 are arranged in this order from the −Z side to the +Z side along the Z-direction. The light emitters 42 are disposed on the side of the light guide plate 41.

The light guide plate 41 has a rectangular shape in plan view. Light is emitted from a front surface 41a of the light guide plate 41 as described below. A reflective sheet (not illustrated) is disposed on a back surface 41b of the light guide plate 41.

The light emitters 42 emit light toward a side surface 41c of the light guide plate 41. The light emitter 42 is, for example, a light-emitting diode (LED). The light from the light emitter 42 corresponds to the light from the light source device 40. The first light emitter 42a outputs first light in a first color. The second light emitter 42b outputs second light in a second color. The third light emitter 42c outputs third light in a third color. The first color, the second color, and the third color are different from one another: the first color is red, the second color is green, and the third color is blue. The first color, the second color, and the third color are not limited to the colors described above.

The light emitters 42 are disposed facing the side surface 41c of the light guide plate 41 orthogonal to the X-direction. The light emitters 42 are disposed along the Y-direction. Specifically, a plurality of sets of light emitters CL are arranged along the Y-direction, each set of which is composed of one first light emitter 42a, one second light emitter 42b, and one third light emitter 42c arranged along the Y-direction.

Light emitted from the light emitter 42 enters the light guide plate 41 from the side surface 41c, is reflected inside the light guide plate 41 and by the reflective sheet, and is output from the front surface 41a.

The prism sheet 43 refracts the light such that the axis of the light output from the light guide plate 41 is along the Z-direction. The prism sheet 43 includes a plurality of prisms 43a that have a triangular section extending along the Y-direction and face the light guide plate 41. The prisms 43a may be provided facing the diffusion sheet 44. Light output from the prism sheet 43 is incident on the diffusion sheet 44.

The diffusion sheet 44 diffuses the light output from the prism sheet 43. Light output from the diffusion sheet 44 is incident on the display panel 10. The diffusion of light by the diffusion sheet 44 can increase the viewing angle of the display panel 10.

The following describes basic operations of the display device 1 performed when the display panel 10 displays an image. The display panel 10 displays images in the display region DA by a field-sequential color system.

When acquiring the image signals from the external device, the image processing circuit 21 generates color images by separating an image contained in the image signals (which may be hereinafter referred to as an input image Gi) into the color images corresponding to the colors of light output from the light emitters 42.

Specifically, the image processing circuit 21 generates the color images by separating the acquired input image Gi based on the colors of light emitted from the light emitters 42. In other words, the image processing circuit 21 generates a first color image G1 corresponding to the first color (red) of the input image Gi, a second color image G2 corresponding to the second color (green) of the input image Gi, and a third color image G3 corresponding to the third color (blue) of the input image Gi. The first color image G1, the second color image G2, and the third color image G3 are referred to simply as “color images G” when they are not distinguished from one another.

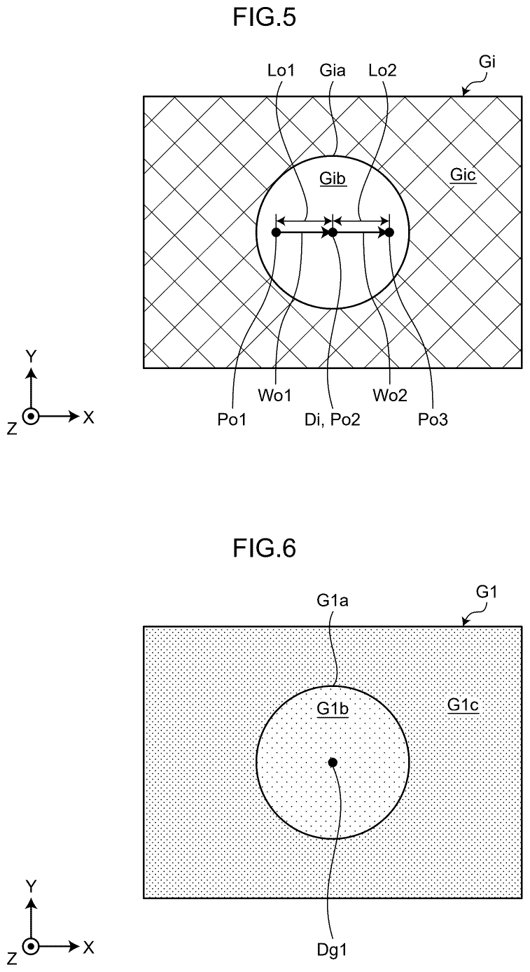

FIG. 5 is a diagram of an example of the input image Gi. The input image Gi illustrated in FIG. 5 has a rectangular shape and has an input image point Di at the center. The image processing circuit 21 overlaps the reference point Ds (refer to FIG. 1) of the display region DA with the input image point Di. When the input image point Di and the reference point Ds according to the present embodiment coincide with each other, the periphery of the input image Gi overlaps that of the display region DA.

The input image Gi includes a circular line drawing part Gia centered at the input image point Di. The input image Gi includes an inner region Gib inside the line drawing part Gia and an outer region Gic outside the line drawing part Gia. In the input image Gi, the color of the line drawing part Gia is black, the color of the inner region Gib is white, and the color of the outer region Gic is gray. In this case, the gradation of the pixels P corresponding to the line drawing part Gia is the smallest, the gradation of the pixels P corresponding to the inner region Gib is the largest, and the gradation of the pixels P corresponding to the outer region Gic is smaller than that corresponding to the inner region Gib.

When acquiring the input image Gi illustrated in FIG. 5, the image processing circuit 21 generates the color images G described below.

FIG. 6 is a diagram of the first color image G1 corresponding to the input image Gi illustrated in FIG. 5. The first color image G1 has a rectangular shape and the same size as the input image Gi and has a first image point Dg1 corresponding to the input image point Di and the reference point Ds at the center. The first color image G1 corresponds to the first color (red) of the input image Gi and includes a first line drawing part G1a, a first inner region G1b, and a first outer region G1c corresponding to the line drawing part Gia, the inner region Gib, and the outer region Gic of the input image Gi. The gradation of the pixels P corresponding to the first line drawing part G1a is the smallest, the gradation of the pixels P corresponding to the first inner region G1b is the largest, and the gradation of the pixels P corresponding to the first outer region G1c is smaller than that corresponding to the first inner region G1b.

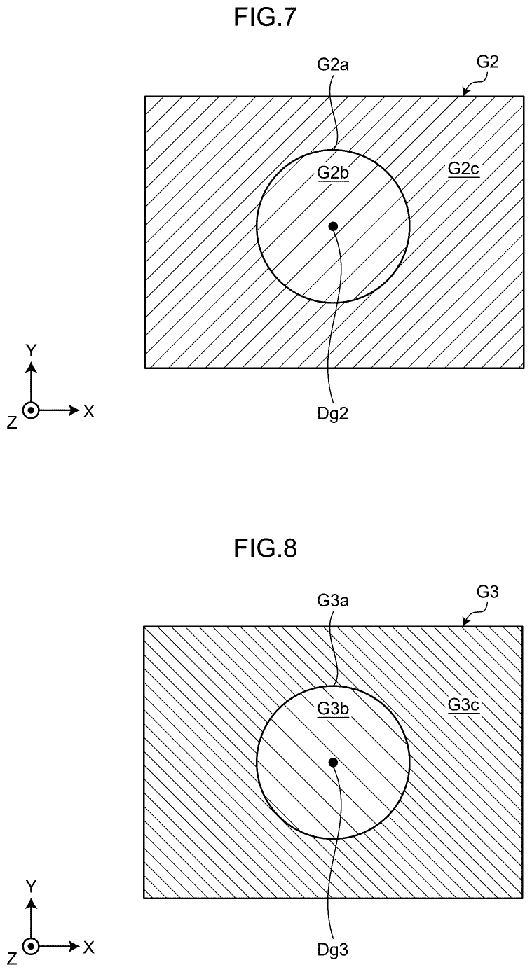

FIG. 7 is a diagram of the second color image G2 corresponding to the input image Gi illustrated in FIG. 5. The second color image G2 has a rectangular shape and the same size as the input image Gi and has a second image point Dg2 corresponding to the input image point Di and the reference point Ds at the center. The second color image G2 corresponds to the second color (green) of the input image Gi and includes a second line drawing part G2a, a second inner region G2b, and a second outer region G2c corresponding to the line drawing part Gia, the inner region Gib, and the outer region Gic of the input image Gi. The gradation of the pixels P corresponding to the second line drawing part G2a is the smallest, the gradation of the pixels P corresponding to the second inner region G2b is the largest, and the gradation of the pixels P corresponding to the second outer region G2c is smaller than that corresponding to the second inner region G2b.

FIG. 8 is a diagram of the third color image G3 corresponding to the input image Gi illustrated in FIG. 5. The third color image G3 has the same rectangular shape as the input image Gi and has a third image point Dg3 corresponding to the input image point Di and the reference point Ds at the center. The third color image G3 corresponds to the third color (blue) of the input image Gi and includes a third line drawing part G3a, a third inner region G3b, and a third outer region G3c corresponding to the line drawing part Gia, the inner region Gib, and the outer region Gic of the input image Gi. The gradation of the pixels P corresponding to the third line drawing part G3a is the smallest, the gradation of the pixels P corresponding to the third inner region G3b is the largest, and the gradation of the pixels P corresponding to the third outer region G3c is smaller than that corresponding to the third inner region G3b.

The gradation of the pixels P corresponding to the first outer region G1c illustrated in FIG. 6, that of the pixels P corresponding to the second outer region G2c illustrated in FIG. 7, and that of the pixels P corresponding to the third outer region G3c illustrated in FIG. 8 are equal to one another.

The image processing circuit 21 generates a pixel signal indicating the gradation of the pixel P. Information on the gradation of the pixel P corresponding to the input image Gi is included in the image signal. The image processing circuit 21 generates a first pixel signal indicating the gradation of the pixel P corresponding to the first color image G1, a second pixel signal indicating the gradation of the pixel P corresponding to the second color image G2, and a third pixel signal indicating the gradation of the pixel P corresponding to the third color image G3 for each of the pixels P. The first pixel signal, the second pixel signal, and the third pixel signal are referred to simply as “pixel signals” when they are not distinguished from one another.

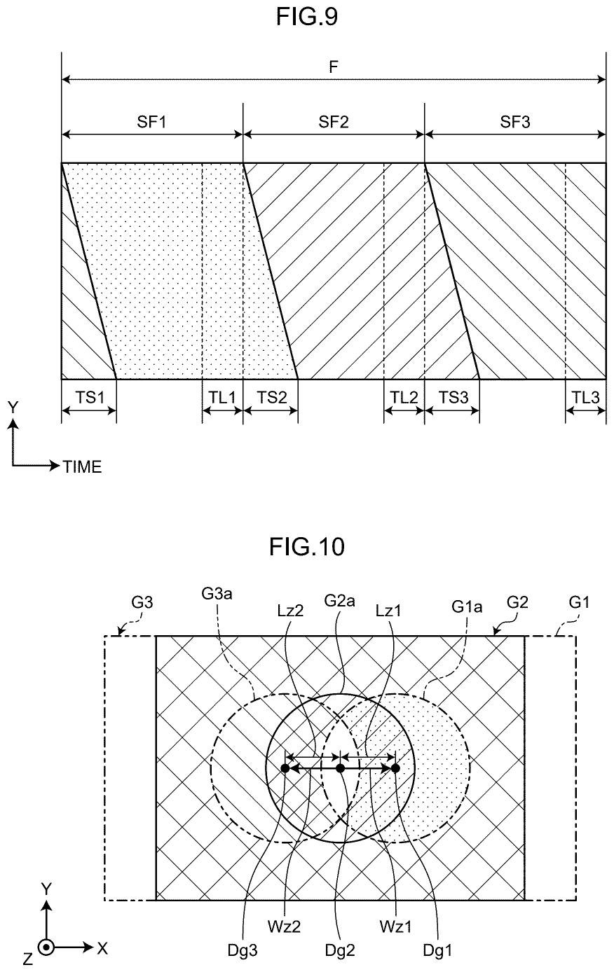

FIG. 9 is a diagram of operations of the drive circuit 20 and the light source device 40 performed when an image is displayed on the display panel 10. In FIG. 9, the horizontal axis indicates time, and the vertical axis indicates the position in the Y-direction of the pixels P in the display region DA. FIG. 9 illustrates the operations of the drive circuit 20 and the light source device 40 per frame F. The frame F includes a first subframe SF1, a second subframe SF2, and a third subframe SF3 in this order.

In the first subframe SF1, the first color image G1 corresponding to the first color (red) is displayed. Specifically, in a first scanning period TS1, the scanning circuit 23 scans the pixels P. The scanning circuit 23 sequentially scans the pixels P from the pixel P on the most +Y side to the pixel P on the most −Y side along the Y-direction. The solid line extending from the +Y side to the −Y side with the elapse of time in the first scanning period TS1 indicates that the scanning circuit 23 scans the pixels P (the same applies to a second scanning period TS2 and a third scanning period TS3, which will be described later). The signal output circuit 22 outputs the first pixel signals corresponding to the pixels P. As a result, the voltage of each pixel P becomes the voltage corresponding to the first pixel signal, and an electric field corresponding to the first pixel signal is generated in the liquid crystal layer 13, thereby changing the orientation of the liquid crystal molecules LM. Thus, the transmittance of the liquid crystal layer 13 is adjusted for each pixel P according to the gradation of the pixel P indicated by the first pixel signal. The voltage applied to the pixel P is retained until it is updated by the second pixel signal in the second subframe SF2 as described below.

Subsequently, in a first emission period TL1, the light source device 40 causes the first light emitters 42a to emit light. First light from the first light emitters 42a enters the display panel 10 and is output from the display region DA with an intensity corresponding to the transmittance of the liquid crystal layer 13. As a result, the first color image G1 is displayed in the display region DA. In other words, the first color image G1 is displayed in the first emission period TL1.

In the second subframe SF2, the second color image G2 corresponding to the second color (green) is displayed. Specifically, in the second scanning period TS2, the scanning circuit 23 scans the pixels P. The signal output circuit 22 outputs the second pixel signals corresponding to the pixels P. As a result, the voltage of each pixel P is updated with the voltage corresponding to the second pixel signal, and an electric field corresponding to the second pixel signal is generated in the liquid crystal layer 13, thereby changing the orientation of the liquid crystal molecules LM. Thus, the transmittance of the liquid crystal layer 13 is adjusted for each pixel P according to the gradation of the pixel P indicated by the second pixel signal. The voltage applied to the pixel P is retained until it is updated by the third pixel signal in the third subframe SF3 as described below.

Subsequently, in a second emission period TL2, the light source device 40 causes the second light emitters 42b to emit light. Second light from the second light emitters 42b enters the display panel 10 and is output from the display region DA with an intensity corresponding to the transmittance of the liquid crystal layer 13. As a result, the second color image G2 is displayed in the display region DA. In other words, the second color image G2 is displayed in the second emission period TL2.

In the third subframe SF3, the third color image G3 corresponding to the third color (blue) is displayed. Specifically, in the third scanning period TS3, the scanning circuit 23 scans the pixels P. The signal output circuit 22 outputs the third pixel signals to the pixels P. As a result, the voltage of each pixel P is updated with the voltage corresponding to the third pixel signal, and an electric field corresponding to the third pixel signal is generated in the liquid crystal layer 13, thereby changing the orientation of the liquid crystal molecules LM. Thus, the transmittance of the liquid crystal layer 13 is adjusted for each pixel P according to the gradation of the pixel P indicated by the third pixel signal. The voltage applied to the pixel P is retained until it is updated by the first pixel signal in the first subframe SF1 of the next frame F.

Subsequently, in a third emission period TL3, the light source device 40 causes the third light emitters 42c to emit light. Third light from the third light emitters 42c enters the display panel 10 and is output from the display region DA with an intensity corresponding to the transmittance of the liquid crystal layer 13. As a result, the third color image G3 is displayed in the display region DA. In other words, the third color image G3 is displayed in the third emission period TL3.

The time of one frame F is set to a time required for the human eye to visually recognize light obtained by combining the first light, the second light, and the third light output from the display region DA in one frame F. In other words, the human eye recognizes light in the color and gradation obtained by combining the first color, the second color, and the third color. Therefore, by displaying the first color image G1, the second color image G2, and the third color image G3 in this order as described above, the user visually recognizes an image obtained by combining the first color image G1, the second color image G2, and the third color image G3. In other words, the image visually recognized by the user corresponds to the input image Gi.

The display device 1 with the configuration described above may possibly cause color breaking (what is called color breakup) described below.

For example, let us assume a case where the position of the user's point of view (which may be hereinafter referred to as a gaze point) on the display region DA moves in the order of a first position Po1, a second position Po2, and a third position Po3 illustrated in FIG. 5 when the image illustrated in FIG. 5 is displayed in the display region DA. The first position Po1 is positioned on the −X side in the X-direction with respect to the second position Po2. The second position Po2 coincides with the input image point Di. The third position Po3 is positioned on the +X side in the X-direction with respect to the second position Po2. In the following description, the direction from the first position Po1 to the second position Po2 is referred to as a first movement direction Wo1, the direction from the second position Po2 to the third position Po3 is referred to as a second movement direction Wo2, the distance between the first position Po1 and the second position Po2 is referred to as a first movement distance Lo1, and the distance between the second position Po2 and the third position Po3 is referred to as a second movement distance Lo2.

Let us assume a case where the gaze point is at the first position Po1 when the first color image G1 is displayed, the gaze point is at the second position Po2 when the second color image G2 is displayed, and the gaze point is at the third position Po3 on the input image Gi when the third color image G3 is displayed. In this case, color breaking (what is called color breakup) occurs, in which the user visually recognizes an afterimage of the first color image G1, the second color image G2, and the third color image G3.

FIG. 10 is a diagram of an example of the image visually recognized by the user when color breakup occurs. In FIG. 10, the first color image G1 is indicated by the alternate long and short dash line, the second color image G2 by the solid line, and the third color image G3 by the alternate long and two short dashes line.

When the gaze point moves as described above, the position of the color image G is recognized as the position of the second image point Dg2 corresponding to the average position of the movement of the line of sight during display. Specifically, the first color image G1 is visually recognized by the user in such a manner that the first image point Dg1 deviates, with respect to the second image point Dg2 of the second color image G2, along a first deviation direction Wz1 that is the same direction as the first movement direction Wo1 illustrated in FIG. 5. The third color image G3 is visually recognized by the user in such a manner that the third image point Dg3 deviates, with respect to the second image point Dg2 of the second color image G2, along a second deviation direction Wz2 that is the opposite direction to the second movement direction Wo2 illustrated in FIG. 5.

A first deviation amount Lz1, which is the amount of deviation between the first color image G1 and the second color image G2 visually recognized by the user, is substantially equal to the first movement distance Lo1 illustrated in FIG. 5, and a second deviation amount Lz2, which is the amount of deviation between the second color image G2 and the third color image G3 visually recognized by the user, is substantially equal to the second movement distance Lo2 illustrated in FIG. 5. The second color image G2 is visually recognized by the user with the second image point Dg2 coinciding with the reference point Ds of the display region DA.

In this case, in the regions where the three inner regions of the first inner region G1b, the second inner region G2b, and the third inner region G3b of the first color image G1, the second color image G2, and the third color image G3 do not overlap, the user visually recognizes the colors other than white and gray of the input image Gi (e.g., the first color, the second color, and the third color, and colors obtained by combining two colors out of the first color, the second color, and the third color).

The drive circuit 20 reduces the occurrence of the color breakup described above. The following describes the operations of the drive circuit 20 to reduce the occurrence of the color breakup. In the following description, the drive circuit 20 acquires the input image Gi illustrated in FIG. 5 in the frame F next to the current frame F (which may be hereinafter referred to as “next frame F”), and the position of the gaze point moves in the order of the first position Po1, the second position Po2, and the third position Po3 when the first color image G1, the second color image G2, and the third color image G3 are displayed.

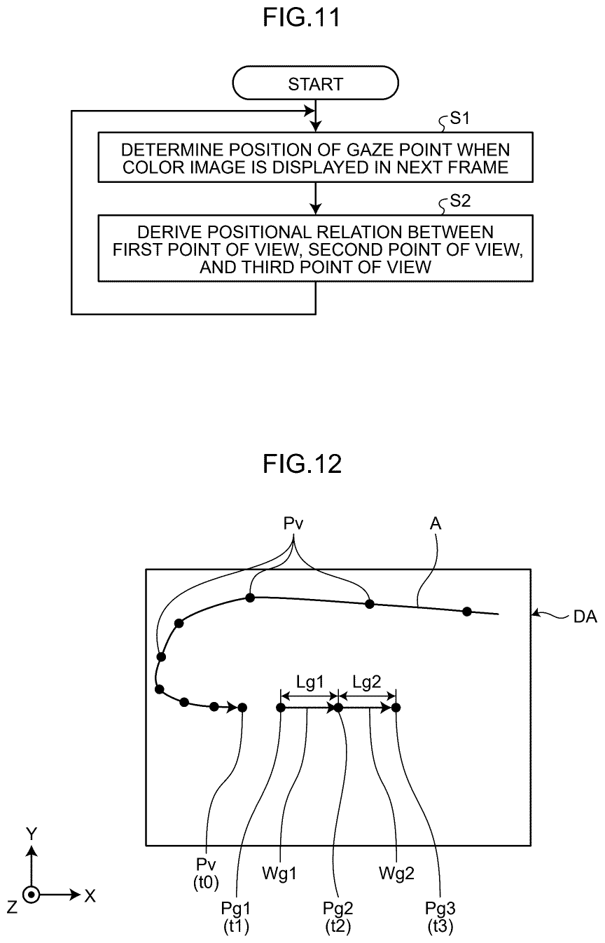

FIG. 11 is a flowchart executed by the image processing circuit 21. The image processing circuit 21 estimates (determines) the position of the gaze point when displaying the color image G in the next frame F by executing the flowchart in FIG. 11. The image processing circuit 21 repeatedly executes the flowchart in FIG. 11 for each frame F. As described above, the image processing circuit 21 always holds the latest data (detection results of the line-of-sight detection sensor 30) of the number of pieces for the predetermined time. The data held by the image processing circuit 21 corresponds to the gaze point.

FIG. 12 is a diagram of an example of the position of a gaze point Pv when the color image G is displayed. FIG. 12 illustrates the positions of a plurality of gaze points Pv from a point of time that is a predetermined time earlier than the current point of time (time t0) to the current point of time, and the arrow A passing through the gaze points Pv. The arrow A indicates the locus of the gaze point Pv. The position of the gaze point Pv at the current point of time corresponds to the latest gaze point Pv. The positions of the gaze points Pv are not limited to those illustrated in FIG. 12.

The image processing circuit 21 determines the position of the gaze point Pv when the color image G is displayed in the next frame F at Step S1 in FIG. 11. In the following description, the gaze points Pv when the first color image G1, the second color image G2, and the third color image G3 are displayed in the next frame F (e.g., when the first color image G1, the second color image G2, and the third color image G3 start to be displayed) are referred to as a first point of view Pg1, a second point of view Pg2, and a third point of view Pg3, respectively. In other words, the positions of the first point of view Pg1, the second point of view Pg2, and the third point of view Pg3 correspond to the first position Po1, the second position Po2, and the third position Po3, respectively, illustrated in FIG. 5.

The image processing circuit 21 determines the first point of view Pg1, the second point of view Pg2, and the third point of view Pg3 using the gaze points Pv to the current frame F illustrated in FIG. 12.

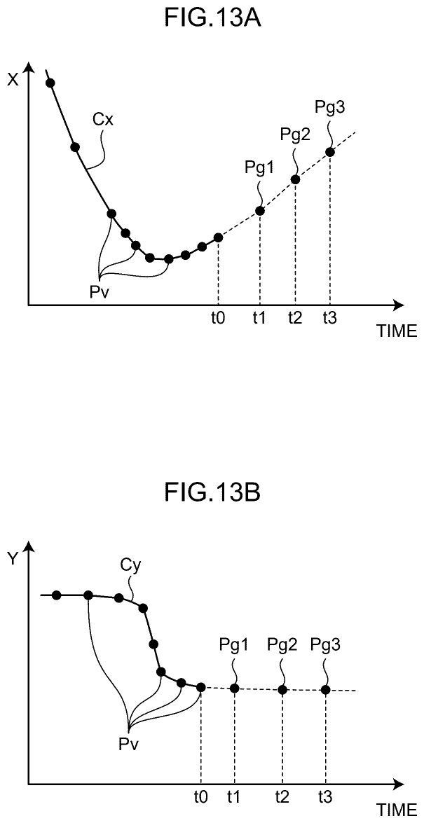

FIG. 13A is a graph indicating the transition in the X-direction of the gaze points Pv illustrated in FIG. 12. In FIG. 13A, the horizontal axis indicates time, and the vertical axis indicates the X-coordinate in the display region DA. FIG. 13B is a graph indicating the transition in the Y-direction of the gaze points Pv illustrated in FIG. 12. In FIG. 13B, the horizontal axis indicates time, and the vertical axis indicates the Y-coordinate in the display region DA.

The image processing circuit 21 generates approximate curves Cx and Cy using the positions of the gaze points Pv for the transition in the X-direction of the gaze point Pv illustrated in FIG. 13A and the transition in the Y-direction of the gaze point Pv illustrated in FIG. 13B, respectively. In FIGS. 13A and 13B, the approximate curves Cx and Cy to the current point of time (time t0) are indicated by the solid lines, and the approximate curves Cx and Cy after the current point of time are indicated by the dashed lines.

The image processing circuit 21 identifies (estimates) the points on the dashed approximate curves Cx and Cy corresponding to first time t1, second time t2, and third time t3 when the first color image G1, the second color image G2, and the third color image G3 are displayed in the next frame F, as the first point of view Pg1, the second point of view Pg2, and the third point of view Pg3. The image processing circuit 21 obtains the X-and Y-coordinates of the first point of view Pg1, the second point of view Pg2, and the third point of view Pg3. FIG. 12 illustrates the first point of view Pg1, the second point of view Pg2, and the third point of view Pg3 determined as described above.

Thus, the image processing circuit 21 determines the first point of view Pg1 when the first color image G1 is displayed, the second point of view Pg2 when the second color image G2 is displayed, and the third point of view Pg3 when the third color image G3 is displayed, using the gaze point Pv identified based on the detection results of the line-of-sight detection sensor 30.

The image processing circuit 21 derives the positional relation between the first point of view Pg1, the second point of view Pg2, and the third point of view Pg3 at Step S2 in FIG. 11.

The image processing circuit 21 first derives the positional relation between the first point of view Pg1 and the second point of view Pg2. Specifically, the image processing circuit 21 uses the X- and Y-coordinates of the first point of view Pg1 and the second point of view Pg2 to derive a first determination direction Wg1 with the first point of view Pg1 illustrated in FIG. 12 as the start point and the second point of view Pg2 as the end point. The drive circuit 20 calculates a first determination distance Lg1, which is the distance between the first point of view Pg1 and the second point of view Pg2.

The image processing circuit 21 derives the positional relation between the second point of view Pg2 and the third point of view Pg3. Specifically, the image processing circuit 21 uses the X-and Y-coordinates of the second point of view Pg2 and the third point of view Pg3 to derive a second determination direction Wg2 with the second point of view Pg2 illustrated in FIG. 12 as the start point and the third point of view Pg3 as the end point. The drive circuit 20 calculates a second determination distance Lg2, which is the distance between the second point of view Pg2 and the third point of view Pg3.

When Step S2 in FIG. 11 is finished, the image processing circuit 21 performs the processing at Step S1 again.

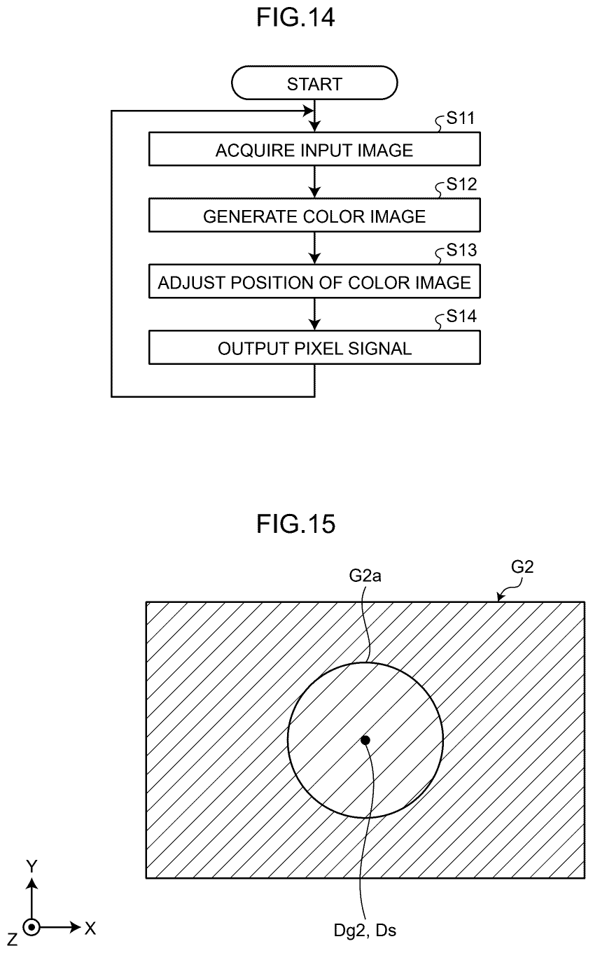

FIG. 14 is a flowchart executed by the image processing circuit 21. The drive circuit 20 displays the first color image G1, the second color image G2, and the third color image G3 by executing the flowchart in FIG. 14. The image processing circuit 21 repeatedly executes the flowchart in FIG. 14 for each frame F. The following describes a case where the drive circuit 20 displays the first color image G1, the second color image G2, and the third color image G3 in the next frame F.

The image processing circuit 21 acquires the input image Gi at Step S11 in FIG. 14. Subsequently, at Step S12, the image processing circuit 21 generates the color images G by separating the input image Gi by the colors as described above.

The image processing circuit 21 adjusts the positions of the color images G with respect to the display region DA at Step S13. Specifically, the image processing circuit 21 adjusts the positions of the first color image G1, the second color image G2, and the third color image G3 with respect to the display region DA based on the positional relation between the first point of view Pg1, the second point of view Pg2, and the third point of view Pg3 determined as described above.

FIG. 15 is a diagram of the second color image G2 the position of which is adjusted with respect to the display region DA. The image processing circuit 21 overlaps the reference point Ds of the display region DA with the second image point Dg2 for the position of the second color image G2 corresponding to the second color (green) with respect to the display region DA. In this case, the periphery of the second color image G2 overlaps that of the display region DA. In other words, the position of the second color image G2 coincides with that of the input image Gi and corresponds to the reference position for adjusting the position of the color image G.

FIG. 16 is a diagram of the first color image G1 the position of which is adjusted with respect to the display region DA. In FIG. 16, the periphery of the first color image G1 before the position is adjusted is indicated by the dashed line, and the first color image G1 after the position is adjusted is indicated by the solid line. The image processing circuit 21 adjusts the position of the first color image G1 corresponding to the first color (red) based on the positional relation between the second color image G2 and the first color image G1.

Specifically, the image processing circuit 21 adjusts the position of the first color image G1 such that a first adjustment direction Wt1, which is the direction from the second image point Dg2 to the first image point Dg1, is the same as the opposite direction to the direction from the first point of view Pg1 to the second point of view Pg2 (first determination direction Wg1 illustrated in FIG. 12), and that a first adjustment distance Lt1, which is the distance between the second image point Dg2 and the first image point Dg1, is equal to the distance between the first point of view Pg1 and the second point of view Pg2 (first determination distance Lg1 illustrated in FIG. 12).

By determining the first point of view Pg1 and the second point of view Pg2 as described above, the first determination direction Wg1 illustrated in FIG. 12 is substantially along the first movement direction Wo1 illustrated in FIG. 5 and the first deviation direction Wz1 illustrated in FIG. 10, and the first determination distance Lg1 illustrated in FIG. 12 is substantially equal to the first movement distance Lo1 illustrated in FIG. 5 and the first deviation amount Lz1 illustrated in FIG. 10. Therefore, the first adjustment direction Wt1 illustrated in FIG. 16 is substantially along the opposite direction to the first deviation direction Wz1 illustrated in FIG. 10, and the first adjustment distance Lt1 illustrated in FIG. 16 is substantially equal to the first deviation amount Lz1 illustrated in FIG. 10.

As described above, the position of the second color image G2 is adjusted such that the second image point Dg2 overlaps the reference point Ds of the display region DA, and the position of the first color image G1 is adjusted to deviate with respect to the second color image G2. Therefore, the position of the first color image G1 is adjusted to deviate with respect to the display region DA. Specifically, the position of the first color image G1 is adjusted such that the direction from the reference point Ds to the first image point Dg1 is the first adjustment direction Wt1 and that the distance between the reference point Ds and the first image point Dg1 is the first adjustment distance Lt1.

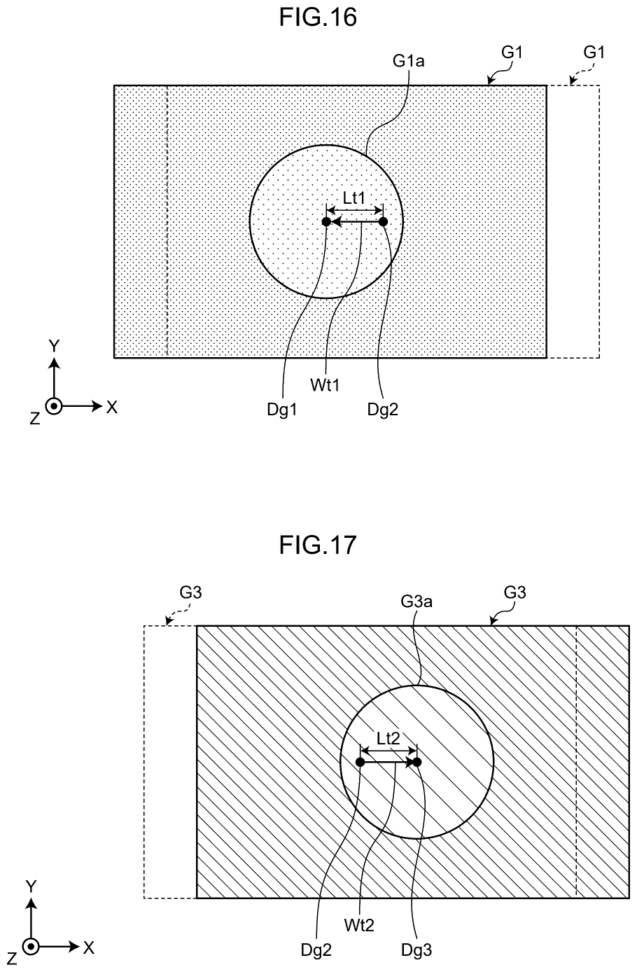

FIG. 17 is a diagram of the third color image G3 the position of which is adjusted with respect to the display region DA. In FIG. 17, the periphery of the third color image G3 before the position is adjusted is represented by the dashed line, and the third color image G3 after the position is adjusted is represented by the solid line. The image processing circuit 21 adjusts the position of the third color image G3 corresponding to the third color (blue) based on the positional relation between the second color image G2 and the third color image G3.

Specifically, the image processing circuit 21 adjusts the position of the third color image G3 such that a second adjustment direction Wt2, which is the direction from the second image point Dg2 to the third image point Dg3, is the same as the direction from the second point of view Pg2 to the third point of view Pg3 (second determination direction Wg2 illustrated in FIG. 12), and that a second adjustment distance Lt2, which is the distance between the second image point Dg2 and the third image point Dg3, is equal to the distance between the second point of view Pg2 and the third point of view Pg3 (second determination distance Lg2 illustrated in FIG. 12).

By determining the second point of view Pg2 and the third point of view Pg3 as described above, the second determination direction Wg2 illustrated in FIG. 12 is substantially along the second movement direction Wo2 illustrated in FIG. 5 and the opposite direction to the second deviation direction Wz2 illustrated in FIG. 10. The second determination distance Lg2 illustrated in FIG. 12 is substantially equal to the second movement distance Lo2 illustrated in FIG. 5 and the second deviation amount Lz2 illustrated in FIG. 10. Therefore, the second adjustment direction Wt2 illustrated in FIG. 17 is substantially along the opposite direction to the second deviation direction Wz2 illustrated in FIG. 10, and the second adjustment distance Lt2 illustrated in FIG. 17 is substantially equal to the second deviation amount Lz2 illustrated in FIG. 10.

As described above, the position of the second color image G2 is adjusted such that the second image point Dg2 overlaps the reference point Ds of the display region DA, and the position of the third color image G3 is adjusted to deviate with respect to the second color image G2. Therefore, the position of the third color image G3 is adjusted to deviate with respect to the display region DA. Specifically, the position of the third color image G3 is adjusted such that the direction from the reference point Ds to the third image point Dg3 is the second adjustment direction Wt2 and that the distance between the reference point Ds and the third image point Dg3 is the second adjustment distance Lt2.

If the adjustment of the position of the first color image G1 creates a region with no image between the periphery of the display region DA and the periphery of the first color image G1, the image processing circuit 21 may generate, in the region with no image, an image identical to the periphery of the first color image G1 adjacent to the region with no image and add it to the first color image G1. The same applies to the second color image G2 and the third color image G3.

The image processing circuit 21 outputs the pixel signals corresponding to the color image G the position of which is adjusted at Step S14 in FIG. 14. Specifically, the image processing circuit 21 generates the pixel signals corresponding to each of the first color image G1 illustrated in FIG. 15, the second color image G2 illustrated in FIG. 16, and the third color image G3 illustrated in FIG. 17, and outputs the generated pixel signals. As a result, the first color image G1 illustrated in FIG. 16, the second color image G2 illustrated in FIG. 15, and the third color image G3 illustrated in FIG. 17 are displayed in this order in the display region DA.

When the gaze point Pv moves in the order of the first position Po1, the second position Po2, and the third position Po3 illustrated in FIG. 5, the second color image G2 illustrated in FIG. 15 is visually recognized with no deviation with respect to the display region DA as described above. In other words, the second color image G2 illustrated in FIG. 15 is visually recognized with the second image point Dg2 overlapping the reference point Ds.

In this case, the first color image G1 illustrated in FIG. 16 is visually recognized to deviate with respect to the second color image G2 by the first deviation amount Lz1 along the first deviation direction Wz1 illustrated in FIG. 10 as described above. As described above, the first adjustment direction Wt1 is substantially along the opposite direction to the first deviation direction Wz1 illustrated in FIG. 10, and the first adjustment distance Lt1 is substantially equal to the first deviation amount Lz1 illustrated in FIG. 10. Therefore, the first color image G1 illustrated in FIG. 16 is visually recognized with the first image point Dg1 substantially overlapping the reference point Ds.

In this case, the third color image G3 illustrated in FIG. 17 is visually recognized to deviate with respect to the second color image G2 by the second deviation amount Lz2 along the second deviation direction Wz2 illustrated in FIG. 10 as described above. As described above, the second adjustment direction Wt2 is substantially along the opposite direction to the second deviation direction Wz2 illustrated in FIG. 10, and the second adjustment distance Lt2 is substantially equal to the second deviation amount Lz2 illustrated in FIG. 10. Therefore, the third color image G3 illustrated in FIG. 17 is visually recognized with the third image point Dg3 substantially overlapping the reference point Ds.

Thus, the user visually recognizes the first color image G1 illustrated in FIG. 16, the second color image G2 illustrated in FIG. 15, and the third color image G3 illustrated in FIG. 17 with the first image point Dg1, the second image point Dg2, and the third image point Dg3 overlapping one another. In other words, the image visually recognized by the user is an image in which the first line drawing part G1a, the second line drawing part G2a, and the third line drawing part G3a overlap one another, and corresponds to the input image Gi illustrated in FIG. 5.

When Step S14 in FIG. 14 is finished, the image processing circuit 21 performs the processing at Step S11 again.

Thus, the image processing circuit 21 adjusts the positions of the color images G with respect to the display region DA, thereby reducing the occurrence of color breakup in the display device 1 that displays images by the field-sequential color system.

As described above, the drive circuit 20 causes the reference point Ds to coincide with the second image point Dg2 for the position of the second color image G2 with respect to the display region DA, whereby the second color image G2 (FIG. 15) the position of which is adjusted has no deviation with respect to the display region DA. In this case, the first color image G1 (FIG. 16) and the third color image G3 (FIG. 17) the positions of which are adjusted have a deviation with respect to the display region DA as described above. In this state, the image visually recognized by the user corresponds to an image in which the input image Gi does not deviate with respect to the display region DA.

If the image processing circuit 21 causes the reference point Ds to coincide with the first image point Dg1 for the position of the first color image G1 with respect to the display region DA, the first color image G1 the position of which is adjusted has no deviation with respect to the display region DA, and the second color image G2 and third color image G3 the positions of which are adjusted have a deviation with respect to the display region DA. However, the amount of deviation of the third color image G3 with respect to the display region DA when the reference point Ds coincides with the first image point Dg1 is larger than the amount of deviation of the third color image G3 with respect to the display region DA when the reference point Ds coincides with the second image point Dg2, and the image visually recognized by the user corresponds to an image in which the input image Gi deviates with respect to the display region DA. The same applies to a case where the image processing circuit 21 causes the reference point Ds to coincide with the third image point Dg3 and the first color image G1 and the second color image G2 the positions of which are adjusted deviate with respect to the display region DA. Therefore, when the image processing circuit 21 causes the reference point Ds to coincide with the second image point Dg2 as described above, the user can visually recognize the input image Gi more appropriately in the display region DA.

As described above, the second color corresponding to the second color image G2 is green. Humans are more likely to visually recognize green than red and blue. The second color image G2 (FIG. 15) the position of which is adjusted as described above has no deviation with respect to the display region DA. Therefore, the user visually recognizes the second color image G2 corresponding to green, which is more likely to be visually recognized, with no deviation with respect to the display region DA, thereby visually recognizing the input image Gi more appropriately in the display region DA than when visually recognizing one of the first color image G1 corresponding to red and the third color image G3 corresponding to blue with no deviation with respect to the display region DA.

### Display System 2

Next, a display system 2 according to the embodiment of the present disclosure is described.

FIG. 18 is a perspective view of a display system 2 according to the embodiment of the present disclosure. Examples of the images displayed by the display system 2 include, but are not limited to, computer graphic video images, 360-degree real video images, etc.

The display system 2 incorporates a video signal source Sg. The display system 2 may acquire input images from an external device.

Output images from the video signal source Sg include two different output images using the parallax of both eyes of the user. The two output images are an input image for the user's right eye and an input image for the user's left eye.

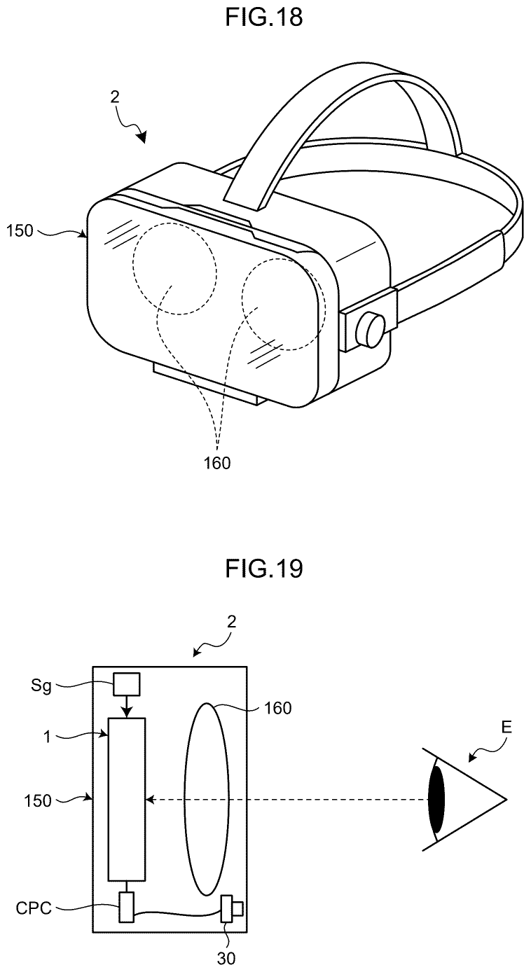

FIG. 19 is a schematic of the configuration of the display system 2. As illustrated in FIGS. 18 and 19, the display system 2 includes a wearable member 150, two lenses 160, the display device 1 described above, and the video signal source Sg.

The wearable member 150 is worn on the user's head to cover both eyes of the user. Examples of the wearable member 150 include, but are not limited to, a headset, goggles, a helmet, a mask, etc. The two lenses 160 and two display devices 1 are fixed to the wearable member 150. The wearable member 150 may further include an output unit (not illustrated) that outputs sound signals output from the video signal source Sg.

The two lenses 160 are disposed at the positions facing user's eyes E. The lens 160 is a convex lens made of glass, for example. The two lenses 160 correspond to the eyes of the user. The lens 160 is disposed between the display device 1 and the user's eye E.

With the effect of the lens 160, light output from the display device 1 is condensed to the user's eye E, and the user visually recognizes a magnified image of the image displayed in the display region DA.

The display devices 1 are disposed on the opposite side to the user's eyes E with the two lenses 160 therebetween. The line-of-sight detection sensor 30 is provided to the wearable member 150 and is electrically coupled to the control substrate CPC.

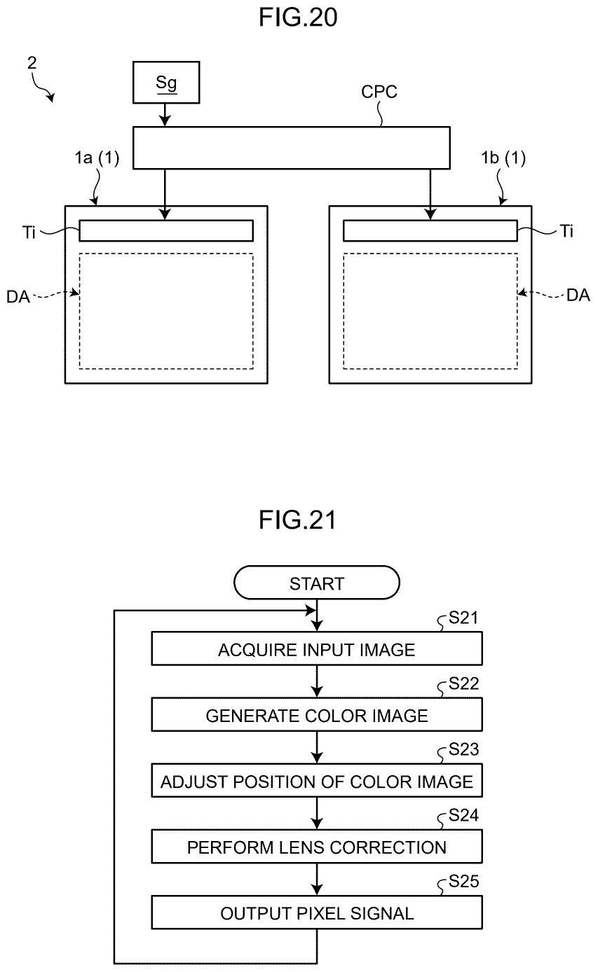

FIG. 20 is a block diagram of the display system 2. The display system 2 includes two display devices 1. In other words, the display system 2 includes a first display device 1a and a second display device 1b. The first display device 1a and the second display device 1b have the same configuration as the display device 1 described above. Specifically, the first display device 1a and the second display device 1b each include the display panel 10, the drive circuit 20, the line-of-sight detection sensor 30, and the light source device 40 as in the display device 1 described above. In other words, in the subframes SF1, SF2, and SF3 of the frame F illustrated in FIG. 9, the first color image is displayed in the first emission period TL1, the second color image is displayed in the second emission period TL2, and the third color image is displayed in the third emission period TL3.

The first display device 1a acquires an input image for the left eye. The display region DA of the first display device 1a faces the user's left eye. The display region DA of the second display device 1b acquires an input image for the right eye. The second display device 1b faces the user's right eye. In the following description, the first display device 1a and the second display device 1b are each referred to simply as the “display device 1” when they are not distinguished from each other. While the control substrate CPC of the first display device 1a and the control substrate CPC of the second display device 1b are integrated, they may be separate.

The display system 2 may include one display device 1. In this case, the image for the left eye is displayed in the region corresponding to the left eye in the display region DA, and the image for the right eye is displayed in the region corresponding to the right eye.

Next, the operations of the display device 1 that displays images in the display region DA is described, mainly on the differences from the operations of the display device 1 described above.

The image processing circuit 21 executes the flowchart illustrated in FIG. 11 in the same manner as described above to determine the position of the gaze point Pv when displaying the color image G.

FIG. 21 is a flowchart executed by the image processing circuit 21 to display the color image G in the display device 1 included in the display system 2. In the display system 2, the image processing circuit 21 executes the flowchart illustrated in FIG. 21 instead of the flowchart in FIG. 14 described above.

The image processing circuit 21 acquires the input image Gi at Step S21.

At Step S22, the image processing circuit 21 generates the color images G by separating the input image Gi by the colors. Specifically, the image processing circuit 21 generates the first color image G1 corresponding to the first color (red) of the input image Gi, the second color image G2 corresponding to the second color (green) of the input image Gi, and the third color image G3 corresponding to the third color (blue) of the input image Gi.

For example, when the input image Gi is the same as the image illustrated in FIG. 5, the first color image G1 generated by the image processing circuit 21 is the same as the image illustrated in FIG. 6, the second color image G2 generated by the image processing circuit 21 is the same as the image illustrated in FIG. 7, and the third color image G3 generated by the image processing circuit 21 is the same as the image illustrated in FIG. 8.

The image processing circuit 21 adjusts the positions of the color images G with respect to the display region DA at Step S23. Specifically, at Step S23, the image processing circuit 21 adjusts the positions of the color images G in the same manner as at Step S13 described above.

If the adjustment of the position of the first color image G1 creates a region with no image between the periphery of the display region DA and the periphery of the first color image G1, the image processing circuit 21 sets the size of the input image Gi larger by the amount of movement of the color image G adjusted by the image processing circuit 21. This mechanism can prevent the creation of the region with no image. The same applies to the second color image G2 and the third color image G3.

Subsequently, the image processing circuit 21 performs lens correction on the color image G at Step S24. Lens correction is the processing of correcting the color image G based on the distortion of the lens 160.

The image visually recognized by the user through the lens 160 is distorted. In other words, distortion is caused by the lens 160. Specifically, the image visually recognized by the user through the lens 160 has distortion (what is called pincushion distortion) that makes the periphery of the image displayed in the display region DA appear expanded. In other words, in the distortion caused by the lens 160, the degree of distortion from the center of the color image G toward the outer side in the radial direction increases from the center of the image displayed in the display region DA toward the outer side in the radial direction (side away from the center of the image).

To address this, the image processing circuit 21 corrects the color image G to reduce the distortion caused by the lens 160. Specifically, the image processing circuit 21 corrects the color image G such that the color image G has distortion (what is called barrel distortion) that makes the center of the image appear bulging. In other words, in the corrected color image G, the degree of distortion toward the center of the image increases as further away from the center of the color image G.

In other words, the image processing circuit 21 corrects the color image G such that the color image G has distortion in the opposite direction to the direction of distortion caused by the distortion of the lens 160 in the image visually recognized by the user.

The image processing circuit 21 outputs the pixel signals corresponding to the corrected color image G at Step S25. As a result, the corrected first color image G1, the corrected second color image G2, and the corrected third color image G3 are displayed in this order in the display region DA.

By adjusting the positions of the color images G as described above, the user visually recognizes the first color image G1, the second color image G2, and the third color image G3 with the first image point Dg1, the second image point Dg2, and the third image point Dg3 overlapping one another. By correcting the color image G such that the color image G has the distortion that is the reverse of the distortion caused by the lens 160 as described above, the user visually recognizes the first color image G1, the second color image G2, and the third color image G3 with the distortion suppressed. In other words, the image visually recognized by the user corresponds to the input image Gi.

After Step S25 is finished, the image processing circuit 21 performs the processing at Step S21 again.

As described above, the image processing circuit 21 adjusts the position of the color image G with respect to the display region DA and corrects the color image G such that the color image G has distortion. Therefore, color breakup and distortion can be reduced in the display system 2 including the display device 1 that displays images by the field-sequential color system.

The image processing circuit 21 may correct the color image G based on the chromatic aberration of the lens 160 instead of the distortion of the lens 160 at Step S24 described above. In other words, the image processing circuit 21 may correct the color image G by setting different distortion magnitudes for the first color image G1, the second color image G2, and the third color image G3.

The wavelengths of light are shorter in the order of first light in the first color (red), second light in the second color (green), and third light in the third color (blue). Typical optical glasses and resins constituting the lens 160 have a relation between the wavelength and the refractive index called normal dispersion, and the refractive index of the first light, the refractive index of the second light, and the refractive index of the third light increase in this order.

When the input image Gi is separated by the first color, the second color, and the third color, the size of the image visually recognized by the user is larger as the wavelength of light is shorter, and increases in the order of the first color image G1 in the first color, the second color image G2 in the second color, and the third color image G3 in the third color. Therefore, the user visually recognizes the image displayed in the display region DA with the colors misaligned. In other words, the lens 160 causes chromatic aberration.

To address this, the image processing circuit 21 corrects the color image G to reduce the chromatic aberration caused by the lens 160. Specifically, the image processing circuit 21 corrects the color image G such that the size of the color image G increase in the order of the third color image G3 in the third color, the second color image G2 in the second color, and the first color image G1 in the first color. In other words, the sizes of the color images G are corrected such that a size relation thereof is the reverse of the size relation between the first color image G1, the second color image G2, and the third color image G3 caused by the chromatic aberration.

The image processing circuit 21 uses the size of the second color image G2 as a reference. In other words, the size of the second color image G2 is equal to that of the input image Gi.

By correcting the color images G such that the color images G have a size relation that is the reverse of the size relation between the first color image G1, the second color image G2, and the third color image G3 causes by the lens 160, the user visually recognizes the first color image G1, the second color image G2, and the third color image G3 with the chromatic aberration reduced. By adjusting the positions of the color images G as described above, the user visually recognizes the first color image G1, the second color image G2, and the third color image G3 with the first image point Dg1, the second image point Dg2, and the third image point Dg3 overlapping one another. In other words, the image visually recognized by the user corresponds to the input image Gi.

The image processing circuit 21 may correct the color image G based on both distortion and chromatic aberration of the lens 160 at Step S24 described above.

While the exemplary embodiment of the present disclosure has been described, the embodiment is not intended to limit the present disclosure. The contents disclosed according to the embodiment are given by way of example only, and various modifications may be made without departing from the spirit of the present disclosure. Appropriate modifications made without departing from the spirit of the present disclosure naturally fall within the technical scope of the present disclosure.

For example, the image processing circuit 21 may cause the reference point Ds to coincide with the first image point Dg1 for the position of the first color image G1 with respect to the display region DA at Step S13 in FIG. 14 or may cause the reference point Ds to coincide with the third image point Dg3 for the position of the third color image G3 with respect to the display region DA.

One of the first color and the third color corresponding to the first color image G1 and the third color image G3 may be green.

In the display system 2, the display panel 10 may be removably attached to the wearable member 150.

The lens 160 is not limited to a convex lens. The distortion caused by the lens 160 may be distortion that causes the image visually recognized by the user through the lens 160 to have what is called barrel distortion. In this case, the drive circuit 20 corrects the color image G such that the color image G has what is called pincushion distortion.

Out of other advantageous effects achieved by the aspects described in the embodiment above, advantageous effects clearly defined by the description in the present specification or appropriately conceivable by those skilled in the art are naturally achieved by the present disclosure.

What is claimed is:

1. A display device comprising:
a display panel having a display region;
a light source device configured to emit first light in a first color, second light in a second color, and third light in a third color to the display panel in one frame in the order of the first light, the second light, and the third light;
a line-of-sight detection sensor configured to detect a line of sight of a user; and
a drive circuit configured to display an image in the display region based on an image signal, wherein the drive circuit is configured to:
generate a first color image corresponding to the first color, a second color image corresponding to the second color, and a third color image corresponding to the third color based on the image signal;
display the first color image when the first light is emitted, the second color image when the second light is emitted, and the third color image when the third light is emitted;
identify a position of a point of view of the user in the display region based on a detection result of the line-of-sight detection sensor;
use the identified position of the point of view of the user to determine a position of a first point of view serving as the point of view of the user in the display region when the first color image is displayed, a position of a second point of view serving as the point of view of the user in the display region when the second color image is displayed, and a position of a third point of view serving as the point of view of the user in the display region when the third color image is displayed; and
adjust a position of the first color image, a position of the second color image, and a position of the third color image with respect to the display region based on a positional relation between the first point of view, the second point of view, and the third point of view.

2. The display device according to claim 1, wherein
the first color image, the second color image, and the third color image have a first image point, a second image point, and a third image point corresponding to a reference point of the display region,
the drive circuit is configured to:
adjust the position of the first color image such that a direction from the second image point to the first image point is the same as an opposite direction to a direction from the first point of view to the second point of view, and that the distance between the second image point and the first image point is equal to the distance between the first point of view and the second point of view; and
adjust the position of the third color image such that a direction from the second image point to the third image point is the same as a direction from the second point of view to the third point of view, and that the distance between the second image point and the third image point is equal to the distance between the second point of view and the third point of view.

3. The display device according to claim 2, wherein the drive circuit is configured to cause the reference point to coincide with the second image point for the position of the second color image with respect to the display region.

4. The display device according to claim 3, wherein the second color is green.

5. A display system comprising:
the display device according to claim 1; and
a lens, wherein the drive circuit is configured to correct the first color image, the second color image, and the third color image the position of which is adjusted with respect to the display region based on one of distortion and chromatic aberration caused by the lens.
